(19) United States
(12) Patent Application Publication
(10) Pub. No.: US 2025/0181058 A1
(43) Pub. Date: Jun. 5, 2025

(54) COMPUTER SYSTEM, INFORMATION PROCESSING METHOD, AND PROGRAM

(71) Applicant: Hitachi, Ltd., Tokyo (JP)

(72) Inventor: Takahiro NAKANO, Tokyo (JP)

(21) Appl. No.: 18/938,688

(22) Filed: Nov. 6, 2024

(30) Foreign Application Priority Data
Dec. 1, 2023 (JP) 2023-203640

(51) Int. Cl. G05B 19/4155

(52) U.S. Cl. CPC G05B 19/4155; G05B 2219/31372

(57) ABSTRACT

A sensor installation plan is capable of improving productivity while suppressing cost necessary to install a sensor. A computer system stores information of: a process managing production processes of a product, a standard work time of the production processes, a recommended sensor used to monitor the production processes; and record information storing a first record including time necessary for production of the product and a second record including work time of the production processes. The computer system calculates work time of the production process corresponding to the second record, obtains the standard work time of the production process, calculates a variation index in works for each production process using the first record, the calculated work time, and the standard work time, identifies the production process for which installation of the sensor is necessary, and selects the sensor for the identified production process by referring to the recommended sensor information.

### CLAIM OF PRIORITY

The present application claims priority from Japanese patent application JP 2023-203640 filed on Dec. 1, 2023, the content of which is hereby incorporated by reference into this application.

### TECHNICAL FIELD

The present invention relates to migration of session information held by a communication server.

### BACKGROUND ART

To manage a factory producing products, use of a cyber physical production system (CPPS) analyzing a gap between physical information of a factory and cyber information of a virtual space and utilizing it for the management of the factory is being promoted.

By using signals obtained from a sensor, progress of a work, occurrence of abnormality, or the like in a factory can be monitored. For example, Patent Literature 1 describes that “a work monitoring device has: a signal obtaining unit 51 obtaining a detection signal from a sensor which detects the presence/absence of activity in a process, by monitoring motion of an object which occurs in a work place in the process or the power supply of electric facility mounted in the work place; a noise identifying unit 14, based on filter information indicative of a determination condition to determine whether or not an activity state generation signal for generating an active state or an inactive state, included in the obtained detection signal, is proper as a start signal and/or an end signal of a process, identifying, as noise, a signal determined as the signal which is improper; a noise eliminating unit 15 eliminating the identified noise; and process signal output means outputting the detection signal from which noise is eliminated as a work signal, so that a work time measurement system capable of automatically measuring work time in an assembly production line is realized”.

### CITATION LIST

### Patent Literature

Patent Literature 1: Japanese Unexamined Patent Application Publication No. 2007-72724

### SUMMARY OF INVENTION

### Technical Problem

By making various physical information reflected in virtual space, the precision of production management using the CPPS improves. However, there is cost to install a sensor, and the installation space has to be assured.

Consequently, a sensor has to be installed in consideration of the relation of trade-off between improvement in productivity and the cost necessary for installation of the sensor.

The present invention provides a system and a method presenting a sensor installation plan capable of efficiently improving productivity while suppressing cost necessary to install a sensor.

### Solution to Problem

Among embodiments disclosed in the present application, a typical one of summary is briefly described as follows. That is, a computer system includes a processor and a storage device connected to the processor. The storage device stores process information for managing a plurality of production processes of a product manufactured in a factor, standard work time information for managing standard work time of each of the production processes, recommended sensor information for managing a sensor used to monitor each of the production processes, and record information storing a first record including time necessary for production of the product and a second record including work time of at least one of the production processes. The processor calculates work time of the production process corresponding to the second record by using the second record stored in the record information, obtains the standard work time of the production process whose second record is not recorded, from the standard work time information, calculates a variation index indicating variation in works with respect to each of the plurality of production processes by using the first record, the work time calculated, and the standard work time, identifies the production process for which installation of the sensor is necessary on the basis of the variation index, selects the sensor used to monitor the identified production process by referring to the recommended sensor information, and generates display information for displaying the identified production process and the selected sensor.

### Advantageous Effects of Invention

According to the present invention, it is possible to present a sensor installation plan capable of efficiently improving productivity while suppressing cost necessary to install a sensor. Objects, configurations, and effects other than the above will be apparent from the description of the following embodiments.

### BRIEF DESCRIPTION OF DRAWINGS

FIG. 1 is a diagram illustrating a configuration example of a production record managing device of a first embodiment.

FIG. 2 is a diagram illustrating an example of process information in the first embodiment.

FIG. 3 is a diagram illustrating an example of production resource information in the first embodiment.

FIG. 4 is a diagram illustrating an example of record information in the first embodiment.

FIG. 5 is a diagram illustrating an example of standard work time information in the first embodiment.

FIG. 6 is a diagram illustrating an example of work variation information in the first embodiment.

FIG. 7 is a diagram illustrating an example of recommended sensor information in the first embodiment.

FIG. 8 is a diagram illustrating an example of sensor information in the first embodiment.

FIG. 9 is a flowchart for explaining an example of sensor configuration presenting process executed by the production record managing device of the first embodiment.

FIG. 10 is a diagram illustrating an example of a screen presented in a terminal by the production record managing device of the first embodiment.

### DESCRIPTION OF EMBODIMENTS

Embodiments of the invention will now be described with reference to the drawings. The present invention, however, is not interpreted by being limited to the following description of the embodiments. A person skilled in the art will easily understand that a concrete configuration can be changed without departing from the idea or gist of the present invention.

In the configuration of the present invention described hereinafter, the same reference numeral will be designated to the same or similar configuration or function, and repetitive description will be omitted.

Writing such as “the first”, “the second”, and “the third” in the specification is to identify components and does not always limit the number or order.

The position, size, shape, range, and the like of each of the components illustrated in the diagrams and the like may not express the actual position, size, shape, range, and the like in order to make the present invention easily understood. Therefore, the present invention is not limited to the positions, sizes, shapes, ranges, and the like disclosed in the diagrams and the like.

### First Embodiment

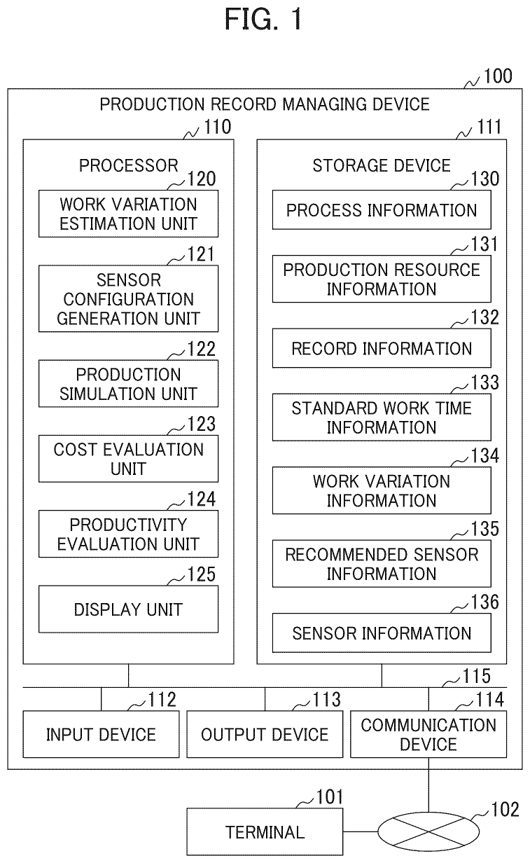

FIG. 1 is a diagram illustrating a configuration example of a production record managing device of a first embodiment.

A production record managing device 100 has a processor 110, a storage device 111, an input device 112, an output device 113, and a communication device 114. The hardware components are connected to one another via a bus 115.

The production record managing device 100 manages record (history) of manufacturing processes of products in a factory, and generates a plan of installation of a sensor for monitoring a production process by using the record. The production record managing device 100 also evaluates the cost and productivity in the case of installing the sensor in accordance with the sensor installation plan. In the following description, a product manufacturing process will be described as a process.

In this case, a product is manufactured through a plurality of processes. The flow of processes for manufacture of a product is managed as a production line.

The communication device 114 is a device for connection to an external device or an external system. In the first embodiment, the communication device 114 connects a terminal 101 via a network 102 such as a LAN (Local Area Network). The terminal 101 is a terminal operated by the user using the production record managing device 100. The production record managing device 100 may be connected to a management system in a factory.

The input device 112 is a keyboard, a mouse, a touch panel, and the like. The output device 113 is a display and the like.

The processor 110 is an arithmetic device controlling the entire production record managing device 100 and executes a program stored in the storage device 111. The processor 110 executes a process in accordance with the program, thereby operating as a function unit (module) realizing a specific function. In the following description, in the case of explaining the process using a function unit as the subject, it indicates that the processor 110 executes the program realizing the function unit.

The processor 110 functions as a work variation estimation unit 120, a sensor configuration generation unit 121, a production simulation unit 122, a cost evaluation unit 123, a productivity evaluation unit 124, and a display unit 125.

The work variation estimation unit 120 estimates the degree of variation in works in each process. The sensor configuration generation unit 121 identifies a process which needs to be monitored, and generates a plan of setting a sensor for monitoring the process.

The production simulation unit 122 performs a production simulation of a product in the case of installing a sensor. The cost evaluation unit 123 calculates the cost required in the case of installing a sensor on the basis of a sensor setting plan. The productivity evaluation unit 124 evaluates the degree of improvement in productivity in the case of installing a sensor on the basis of a sensor installing plan. The index expressing the degree of improvement in productivity may be, for example, the production number of products per unit time. The display unit 125 generates display information.

As the function unit of the production record managing device 100, a plurality of function units may be collected as a one function unit, or one function unit may be divided into a plurality of function units by functions.

The storage device 111 is a memory or the like and stores a program executed by the processor 110 and various information. The production record managing device 100 may have a large-capacity storage device such as an HDD (Hard Disk Drive) and an SSD (Solid State Drive).

The storage device 111 stores process information 130, production resource information 131, record information 132, standard work time information 133, work variation information 134, recommended sensor information 135, and sensor information 136.

The process information 130 is information for managing the process. The production resource information 131 is information for managing a resource executing a work in a process. The resources are, for example, people and a robot. The record information 132 is information for managing record of a production process of a product. The standard work time information 133 is information for managing standard work time of a process. The work variation information 134 is information for managing variation in works in a process. The recommended sensor information 135 is information for managing a sensor which can be used to monitor a process. The sensor information 136 is information for managing a sensor installed in a production line of a product.

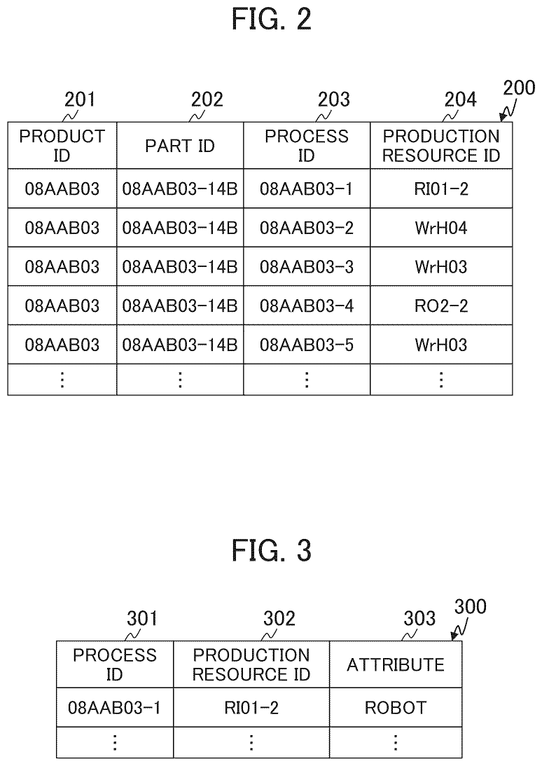

Subsequently, using FIGS. 2 to 8, the information managed by the production record managing device 100 will be described.

FIG. 2 is a diagram illustrating an example of the process information 130 in the first embodiment.

In the process information 130, a table 200 is stored for each production line. The table 200 stores an entry including a product ID 201, a part ID 202, a process ID 203, and a production resource ID 204. One entry exists for a combination of a product and a process.

The product ID 201 is a field storing the ID of a product. The part ID 202 is a field storing the ID of a part as a component of the product. In the part ID 202, the ID of a part used in a work in the process is stored. In the case of a process using no parts, the part ID 202 is blank. The process ID 203 is a field storing the ID of the process. The production resource ID 204 is a field storing the ID of a resource executing the work in the process.

FIG. 3 is a diagram illustrating an example of the production resource information 131 in the first embodiment.

In the production resource information 131, a table 300 is stored for each production line. The table 300 stores an entry including a process ID 301, a production resource ID 302, and an attribute 303. One entry exists for a combination of a process and a resource.

The process ID 301 is a field storing the ID of a process. The production resource ID 302 is a field storing the ID of a resource. In the production resource ID 302, the ID of a resource which can execute a work of the process is stored. A plurality of entries may exist for one process. The attribute 303 is a field storing the attribute of the resource.

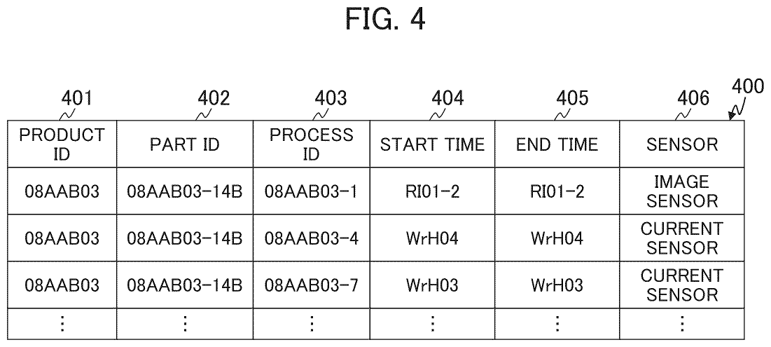

FIG. 4 is a diagram illustrating an example of the record information 132 in the first embodiment.

In the record information 132, a table 400 is stored for each production line. The table 400 stores an entry including a product ID 401, a part ID 402, a process ID 403, start time 404, end time 405, and a sensor 406. One entry exists for a combination of a product and a process.

The product ID 401 is a field storing the ID of a product. The part ID 402 is a field storing the ID of a part. The process ID 403 is a field storing the ID of a process. The start time 404 and the end time 405 are fields storing start time and end time of a work in a process. The sensor 406 is a field storing information of a sensor which monitors a process. In the embodiment, it is assumed that the start time and the end time are known on the basis of a measurement result of a sensor.

In the record information 132, a table managing production time of a product is also stored.

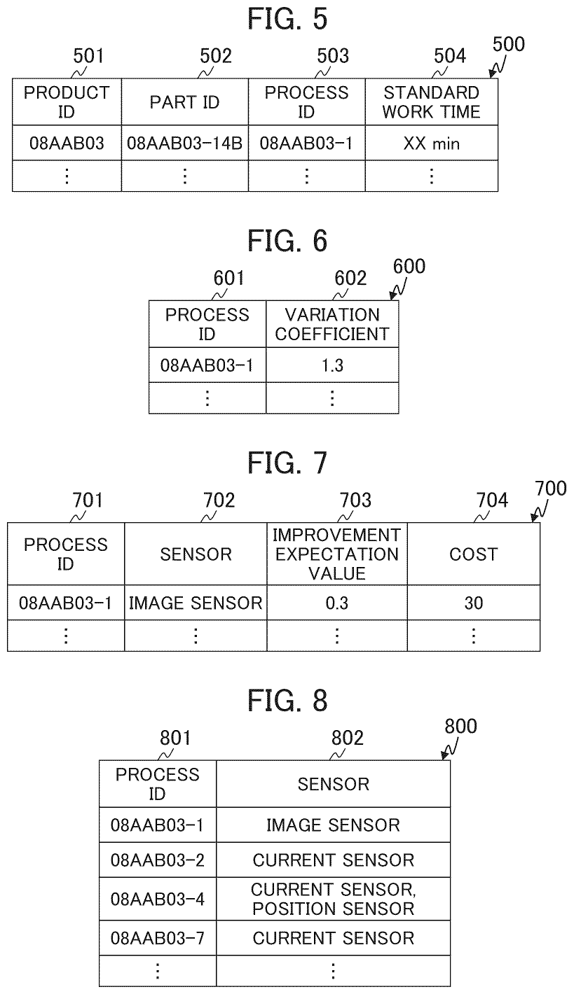

FIG. 5 is a diagram illustrating an example of the standard work time information 133 in the first embodiment.

In the standard work time information 133, a table 500 is stored for each production line. The table 500 stores an entry including a product ID 501, a part ID 502, a process ID 503, and standard work time 504. One entry exists for a combination of a product and a process.

The product ID 501 is a field storing the ID of a product. The part ID 502 is a field storing the ID of a part. The process ID 503 is a field storing the ID of a process. The standard work time 504 is a field storing standard work time of a work in a process.

FIG. 6 is a diagram illustrating an example of the work variation information 134 in the first embodiment.

In the work variation information 134, a table 600 is stored for each production line. The table 600 stores an entry including a process ID 601 and a variation coefficient 602. One entry exists for one process.

The process ID 601 is a field storing the ID of a process. The variation coefficient 602 is a field storing a coefficient expressing variation in works in a process.

In the embodiment, it is assumed that the production time of a product is calculated by Formula (1).

$$\begin{matrix}Formula 1 & \\ PT = {\sum }_{i} {V}_{i} \times {T}_{i} & ( 1 )\end{matrix}$$

PT expresses production time. Suffix i expresses the ID of a process. Tᵢ expresses standard work time of a process. Vᵢ expresses variation coefficient of a process.

FIG. 7 is a diagram illustrating an example of the recommended sensor information 135 in the first embodiment.

In the recommended sensor information 135, a table 700 is stored for each production line. The table 700 stores an entry including a process ID 701, a sensor 702, an improvement expectation value 703, and a cost 704. One entry exists for one process.

The process ID 701 is a field storing the ID of a process. The sensor 702 is a field storing a sensor which can be used for monitoring a work in a process. A plurality of entries may exist for one process. The improvement expectation value 703 is a field storing an improvement expectation value of a variation coefficient by installation of a sensor. The cost 704 is a field storing the cost necessary to install a sensor. In the cost 704 of the embodiment, monetary cost is stored.

FIG. 8 is a diagram illustrating an example of the sensor information 136 in the first embodiment.

In the sensor information 136, a table 800 is stored for each production line. The table 800 stores an entry including a process ID 801 and a sensor 802. One entry exists for one process.

The process ID 801 is a field storing the ID of a process. The sensor 802 is a field storing a sensor installed to monitor a work in a process.

Subsequently, a process executed by the production record managing device 100 will be described.

The production record managing device 100 receives an entry of a record from the terminal 101 and stores it in the record information 132. When the production record managing device 100 is connected to a management system of a factory, the production record managing device 100 can obtain a record from the management system.

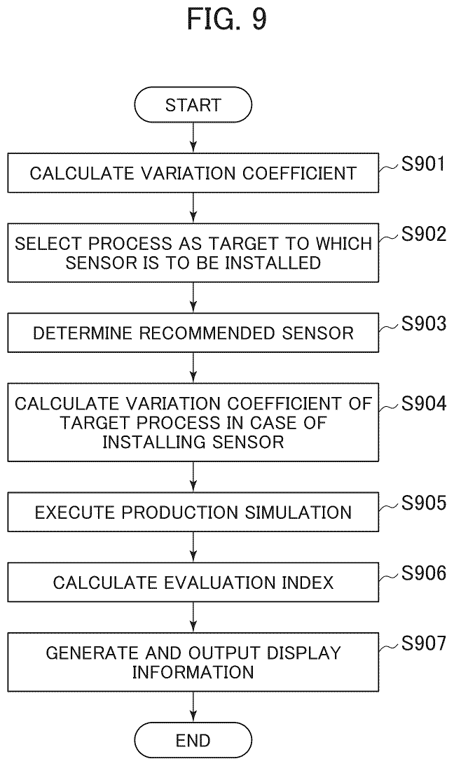

When an instruction to present a sensor configuration is received from the terminal 101, the production record managing device 100 executes a sensor configuration presenting process. FIG. 9 is a flowchart for explaining an example of sensor configuration presenting process executed by the production record managing device 100 of the first embodiment. In the sensor configuration presenting process, processes to be described hereinafter are executed in each production line. The user may designate a production line or a product to be processed.

The work variation estimation unit 120 calculates a variation coefficient (step S901). Concretely, the following processes are executed.

### (S901-1)

The work variation estimation unit 120 reads the table 800 of a production line to be processed from the record information 132.

### (S901-2)

The work variation estimation unit 120 identifies a process whose record exists and calculates work time on the basis of the record of the process. The work time can be calculated by using the start time 404 and the end time 405 of an entry as the record. In the case where there are a plurality of records of the same process, the work variation estimation unit 120 calculates an average value of work times calculated from the records.

### (S901-3)

The work variation estimation unit 120 reads the table 200 of the production line from the process information 130 and reads the table 500 of the production line to be processed from the standard work time information 133.

### (S901-4)

The work variation estimation unit 120 calculates a variation coefficient of each process by solving a mathematical optimization problem using Formula (2).

$$\begin{matrix}Formula ( 2 ) & \\ PT = {\sum }_{j} {V}_{j} \times {T}_{j} + {\sum }_{k} {AT}_{k} & ( 2 )\end{matrix}$$

Suffix j expresses the ID of a process whose record does not exist, and suffix k expresses the ID of a process whose record exists. ATₖ expresses calculated work time. In the mathematical optimization problem, for example, a variation coefficient Vⱼ is calculated so that the difference between production time calculated from Formula (2) and actual production time becomes the minimum. A variation coefficient of a process whose record exists is calculated by using Formula (3).

$$\begin{matrix}Formula ( 3 ) & \\ {AT}_{k} = {V}_{k} \times {T}_{k} & ( 3 )\end{matrix}$$

### (S901-5)

The work variation estimation unit 120 reflects the calculation result in the table 600 of the production line to be processed which is stored in the work variation information 134.

With respect to a process whose record does not exist, the work time can be estimated by using the standard work time information 133. In such a manner, even in the case where there is no record for all of processes, variation in works can be estimated.

The step S901 has been described above.

Subsequently, the sensor configuration generation unit 121 selects a process for which a sensor is to be installed on the basis of variation coefficients (step S902). For example, the sensor configuration generation unit 121 selects a process in which the variation coefficient is the largest. The sensor configuration generation unit 121 may select a process in which the variation coefficient is larger than a threshold. The sensor configuration generation unit 121 may select a process in which the variation coefficient is larger than a threshold and for which a sensor is not installed. A process for which a sensor is not installed is a process whose record does not exist in the table 400.

Subsequently, the sensor configuration generation unit 121 determines a recommended sensor for monitoring the selected process (step S903).

Concretely, the sensor configuration generation unit 121 reads the table 700 of the production line to be processed from the recommended sensor information 135 and retrieves an entry of the selected process. The sensor configuration generation unit 121 determines a sensor which is set in the sensor 702 of the retrieved entry as a recommended sensor.

In the case where a plurality of entries are retrieved, the sensor configuration generation unit 121 selects an entry on the basis of either the improvement expectation value 703 or the cost 704. For example, it is considered to select an entry having the largest improvement expectation value 703.

The sensor configuration generation unit 121 may read the table 800 of the production line to be processed from the sensor information 136, grasp a sensor already installed, and exclude the sensor already installed from candidates.

Subsequently, the production simulation unit 122 calculates a variation coefficient of a work in the target process in the case of installing the determined recommended sensor (step S904).

Concretely, the production simulation unit 122 calculates a variation coefficient by using the variation coefficient 602 of the entry of the selected process in the table 600 and the improvement expectation value 703 of the entry of the sensor determined in the table 700. For example, there may be a calculation method of subtracting the improvement expectation value from the variation coefficient.

Then, the production simulation unit 122 executes a production simulation (step S905). Concretely, the following processes are executed.

### (S905-1)

The production simulation unit 122 reads the table 800 of the production line to be processed from the sensor information 136 and reflects the process result of step S903 into the table 800, thereby generating the table 800 for simulation.

### (S905-2)

The production simulation unit 122 sets a model for simulation. The model for simulation includes a variation coefficient as a parameter.

### (S905-3)

The production simulation unit 122 simulates production of products in the production line by using the model and the table 800.

The process in step S905 has been described above.

Subsequently, the productivity evaluation unit 124 calculates an evaluation index on the basis of the table 800 for simulation and the result of the production simulation (step S906). Concretely, the following processes are executed.

### (S906-1)

The productivity evaluation unit 124 compares the original table 800 and the table 800 for simulation and identifies the sensor added.

### (S906-2)

The productivity evaluation unit 124 refers to the table 700 of the production line to be processed in the recommended sensor information 135 and retrieves an entry corresponding to the added sensor. The productivity evaluation unit 124 obtains the cost 704 of the retrieved entry. The productivity evaluation unit 124 calculates a total value of the cost 704 as a cost index.

### (S906-3)

On the basis of the result of the production simulation, the productivity evaluation unit 124 calculates the number of products generated per unit time, the number of products produced within predetermined time, or the like as a productivity index.

Subsequently, the display unit 125 generates display information on the basis of the table 800 for simulation and the evaluation index and outputs it (step S907).

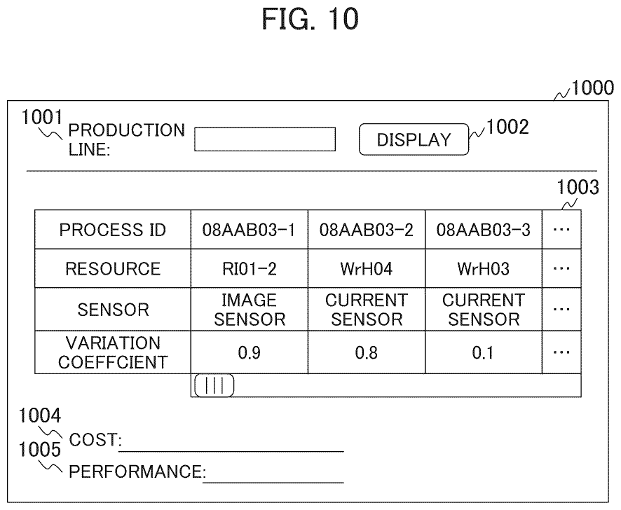

FIG. 10 is a diagram illustrating an example of a screen presented on a terminal 101 by the production record managing device 100 of the first embodiment.

A screen 1000 includes an entry field 1001 and an operation button 1002. The entry field 1001 is a field in which a production line is entered. The user inputs identification information of the production line in the entry field 1001 and presses the operation button 1002. In the case where the operation is accepted, the display unit 125 displays a table 1003 and display fields 1004 and 1005 based on the display information. The table 1003 corresponds to the table 800 for simulation. The display field 1004 is a field displaying a cost index. The display field 1005 is a field displaying a productivity index.

The production record managing device 100 may generate a plan of installing a plurality of sensors, and perform execution of production simulation and calculation of an evaluation index with respect to an installation plan of each of the sensors.

As described above, the production record managing device 100 identifies a process having a large variation in works, and generates a plan of installing a sensor for monitoring the process. By installing a sensor with focus on a process having a large variation in works, productivity can be efficiently improved while suppressing the cost.

The present invention is not limited to the above-described embodiment, but various modifications are included. For example, the configuration has been described in detail in the foregoing embodiment to explain the present invention so as to be easily understood, and the present invention is not always limited to a device having all of the components described above. A part of the configuration of each of the embodiments can be added to another configuration, deleted, or replaced.

A part or all of the components, functions, process units, processing means, and the like may be realized by hardware, for example, by designing it by an integrated circuit. The present invention can be realized also by a program code of software realizing the functions of the embodiment. In this case, a storage medium in which a program code is recorded is provided to a computer, and a processor of the computer reads the program code stored in the storage medium. In this case, the program code itself read from the storage medium realizes the function of the above-described embodiment, and the program code itself and the storage medium storing it are components of the present invention. As a storage medium for supplying such a program code, for example, a flexible disk, a CD-ROM, a DVD-ROM, a hard disk, an SSD (Solid State Drive), an optical disk, a CD-R, a magnetic tape, a non-volatile memory card, a ROM, or the like is used.

A program code realizing the function described in the embodiment can be implemented by, for example, a program or script language in a wide range such as assembler, C/C++, perl, Shell, PHP, Python, Java (registered trademark), or the like.

Further, by distributing a program code of software realizing the function of the embodiment via a network, it may be stored in storing means such as a hard disk, a memory, or the like of a computer or a storage medium such as a CD-RW or CD-R. A processor of a computer may read and execute the program code stored in the storing means or the storage medium.

In the foregoing embodiment, control lines and information lines which are regarded as necessary for explanation are illustrated. All of control lines and information lines in a product are not always illustrated. All of the components may be connected to one another.

### LIST OF REFERENCE SIGNS

100: production record managing device
101: terminal
102: network
110: processor
111: storage device
112: input device
113: output device
114: communication device
115: bus
120: work variation estimation unit
121: sensor configuration generation unit
122: production simulation unit
123: cost evaluation unit
124: productivity evaluation unit
125: display unit
130: process information
131: production resource information
132: record information
133: standard work time information
134: work variation information
135: recommended sensor information
136: sensor information
1000: screen

1. A computer system comprising:
a processor and a storage device connected to the processor, wherein
the storage device stores process information for managing a plurality of production processes of a product manufactured in a factor, standard work time information for managing standard work time of each of the production processes, recommended sensor information for managing a sensor used to monitor each of the production processes, and record information storing a first record including time necessary for production of the product and a second record including work time of at least one of the production processes, and
the processor
calculates work time of the production process corresponding to the second record by using the second record stored in the record information,
obtains the standard work time of the production process whose second record is not recorded, from the standard work time information,
calculates a variation index indicating variation in works with respect to each of the plurality of production processes by using the first record, the work time calculated, and the standard work time,
identifies the production process for which installation of the sensor is necessary on the basis of the variation index,
selects the sensor used to monitor the identified production process by referring to the recommended sensor information, and
generates display information for displaying the identified production process and the selected sensor.

2. The computer system according to claim 1, wherein
the processor identifies the production process in which variation in works is large on the basis of a result of comparison between the variation index and a threshold.

3. The computer system according to claim 2, wherein
the processor calculates the variation index by solving a mathematical optimization problem using the first record, the work time calculated, and the standard work time.

4. The computer system according to claim 3, wherein
the recommended sensor information stores data including the production process, the sensor, and an improvement expectation value of the variation index of the production process by installation of the sensor,
the processor
corrects the variation index of the production process in the case where the selected sensor is installed for the identified production process,
executes simulation of production of the product using the variation index as a parameter,
calculates cost required to install the selected sensor for the identified production process,
calculates an evaluation index for evaluating productivity of the product on the basis of a result of the simulation, and
generates the display information for displaying the identified production process, the sensor selected, the cost, and the evaluation index.

5. The computer system according to claim 4, wherein
the processor presents a screen on the basis of the display information.

6. An information processing method executed by a computer system, wherein
the computer system has a processor and a storage device connected to the processor,
the storage device stores process information for managing a plurality of production processes of a product manufactured in a factor, standard work time information for managing standard work time of each of the production processes, recommended sensor information for managing a sensor used to monitor each of the production processes, and record information storing a first record including time necessary for production of the product and a second record including work time of at least one of the production processes, and
the information processing method comprises:
a first step of allowing the processor to calculate work time of the production process corresponding to the second record by using the second record stored in the record information;
a second step of allowing the processor to obtain the standard work time of the production process whose second record is not recorded from the standard work time information;
a third step of allowing the processor to calculate a variation index indicating variation in works with respect to each of the plurality of production processes by using the first record, the work time calculated, and the standard work time;
a fourth step of allowing the processor to identify the production process for which installation of the sensor is necessary on the basis of the variation index;
a fifth step of allowing the processor to select the sensor used to monitor the identified production process by referring to the recommended sensor information; and
a sixth step of allowing the processor to generate display information for displaying the identified production process and the selected sensor.

7. The information processing method according to claim 6, wherein
the fourth step includes a step of allowing the processor to identify the production process in which variation in works is large on the basis of a result of comparison between the variation index and a threshold.

8. The information processing method according to claim 7, wherein
the third step includes a step of allowing the processor to calculate the variation index by solving a mathematical optimization problem using the first record, the work time calculated, and the standard work time.

9. The information processing method according to claim 8, wherein
the recommended sensor information stores data including the production process, the sensor, and an improvement expectation value of the variation index of the production process by installation of the sensor,
the information processing method comprises:
a step of allowing the processor to correct the variation index of the production process in the case where the sensor selected for the identified production process is installed;
a step of allowing the processor to execute simulation of production of the product using the variation index as a parameter;
a step of allowing the processor to calculate cost required to install the sensor selected for the identified production process; and
a step of allowing the processor to calculate an evaluation index for evaluating productivity of the product on the basis of a result of the simulation, and
the sixth step includes a step of allowing the processor to generate the display information for displaying the identified production process, the sensor selected, the cost, and the evaluation index.

10. The information processing method according to claim 9, further comprising a step of allowing the processor to present a screen on the basis of the display information.

11. A program to be executed by a computer having a processor and a storage device connected to the processor, wherein
the storage device stores process information for managing a plurality of production processes of a product manufactured in a factor, standard work time information for managing standard work time of each of the production processes, recommended sensor information for managing a sensor used to monitor each of the production processes, and record information storing a first record including time necessary for production of the product and a second record including work time of at least one of the production processes, and
the program allows the computer to execute:
a first procedure of calculating work time of the production process corresponding to the second record by using the second record stored in the record information;
a second procedure of obtaining the standard work time of the production process whose second record is not recorded from the standard work time information;
a third procedure of calculating a variation index indicating variation in works for each of the plurality of production processes by using the first record, the work time calculated, and the standard work time;
a fourth procedure of identifying the production process for which installation of the sensor is necessary on the basis of the variation index;
a fifth procedure of selecting the sensor used to monitor the identified production process by referring to the recommended sensor information; and
a sixth procedure of generating display information for displaying the identified production process and the selected sensor.

12. The program according to claim 11, wherein
the fourth procedure includes a procedure of identifying the production process in which variation in works is large on the basis of a result of comparison between the variation index and a threshold.

13. The program according to claim 12, wherein
the third step includes a step of calculating the variation index by solving a mathematical optimization problem using the first record, the work time calculated, and the standard work time.

14. The program according to claim 13, wherein
the recommended sensor information stores data including the production process, the sensor, and an improvement expectation value of the variation index of the production process by installation of the sensor,
the program allows the computer to execute:
a procedure of correcting the variation index of the production process in the case where the sensor selected for the identified production process is installed;
a procedure of executing simulation of production of the product using the variation index as a parameter;
a procedure of calculating cost required to install the sensor selected for the identified production process; and
a procedure of calculating an evaluation index for evaluating productivity of the product on the basis of a result of the simulation, and
the sixth procedure includes a procedure of generating the display information for displaying the identified production process, the sensor selected, the cost, and the evaluation index.

15. The program according to claim 14, further comprising:
a procedure of allowing the computer to present a screen on the basis of the display information.
